(19) United States
(12) Patent Application Publication
(10) Pub. No.: US 2016/0045281 A1
(43) Pub. Date: Feb. 18, 2016

(54) Tooth Removal Cloth

(71) Applicant: Kathleen Ausman, Omaha, NE (US)

(72) Inventor: Kathleen Ausman, Omaha, NE (US)

(21) Appl. No.: 14/824,237

(22) Filed: Aug. 12, 2015

Related U.S. Application Data
(60) Provisional application No. 62/036,279, filed on Aug. 12, 2014.

(51) Int. Cl. A61C 3/14; A61C 19/06

(52) U.S. Cl. CPC A61C 3/14; A61C 19/063

(57) ABSTRACT

A tooth removal cloth is disclosed that facilitates the removal of loose teeth. The tooth removal cloth comprises a moisture absorbing portion and a gripping portion. The gripping portion may include a textured surface. The gripping portion may also include folds for receiving fingers to affect the grip of the tooth removal cloth on a tooth.

### CROSS-REFERENCE TO PRIORITY/PROVISIONAL APPLICATIONS

This application claims priority under 35 U.S.C. §119 of U.S. Provisional Application No. 62/036,279, filed Aug. 12, 2014, which is expressly incorporated by reference in its entirety.

### BACKGROUND

Primary teeth or “baby teeth” first become visible in the human mouth during infancy (e.g., at about 6 months of age) and continue to develop during the first few years of childhood. Between the ages of about 6 to 12 years, the process of exfoliation occurs in which permanent teeth begin to appear and replace the baby teeth. During this process, the baby teeth gradually become increasingly loose and eventually fall out, thereby making room for the permanent teeth. For young children, as the baby teeth begin to loosen, this can be an uncomfortable or scary process, since it is often accompanied by minor bleeding. Consequently, as a baby tooth becomes very loose, a young child may sometimes be hesitant to wiggle their tooth to facilitate its removal.

Many children, parents, and dentists may use their hands to remove primary teeth, but this may be problematic. For children, they may be hesitant to feel the tactile sensation of grabbing their tooth or to see the accompanying bleeding, in addition to hesitancy over the pain. The same may be true for parents helping their child. Additionally, for children, parents, and dentists alike, there are sanitary concerns that come with removing teeth. Fingers and hands can carry germs, dirt and other matter that could be introduced into a person's mouth when a tooth is being extracted by hand.

Other children, parents, and dentists may use tissue, paper towels, or cotton gauze when removing primary teeth, but this too may be problematic. Tissue, paper towels and cotton gauze do not eliminate the ability for blood to pass through and contact the fingers of the person removing or wiggling the tooth. Furthermore, these materials can begin to break apart or tear when saliva and/or blood is absorbed, thus they are not durable.

Dentists may use other tools but this too poses problems. For parents and children, they may not have the time or money to visit their dentist. For dentists, those tools are expensive to purchase and may be less practical for use on primary teeth.

### SUMMARY

A tooth removal cloth for facilitating removal of loose teeth is disclosed. The tooth removal cloth comprises a moisture absorbing portion and a gripping portion. The moisture absorbing portion may be one side of the tooth removal cloth and the gripping portion may be another opposite side of the tooth removal cloth. The gripping portion may be a material that is slip-resistant to strengthen the grip of a person's fingers on a tooth that is being removed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures.

FIG. 1 is a diagram illustrating a first face (e.g., front side) of a tooth removal cloth with a gripping portion in accordance with the present disclosure; and

FIG. 2 is a diagram illustrating the tooth removal cloth folded diagonally, showing the gripping portion and a part of a moisture absorbing portion.

FIG. 3 is a representative illustration of a person that used the tooth removal cloth for extracting a tooth.

FIG. 4 is a representative illustration of a person holding an extracted tooth with the tooth removal cloth, showing part of the gripping portion and part of the moisture absorbing portion.

### DETAILED DESCRIPTION

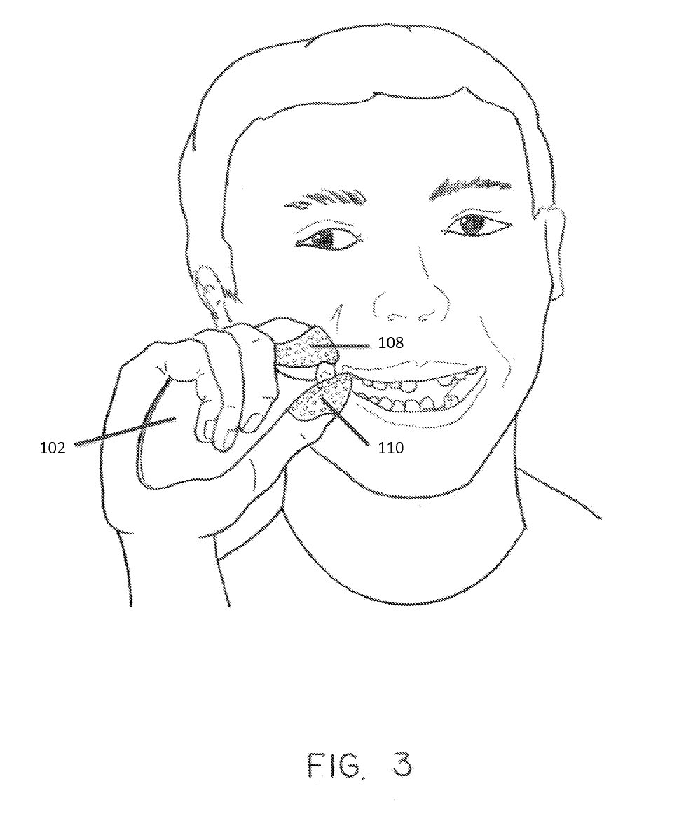

Referring generally to FIGS. 1 through 4 (FIGS. 1-4), a tooth removal cloth in accordance with embodiments of the present disclosure is described herein.

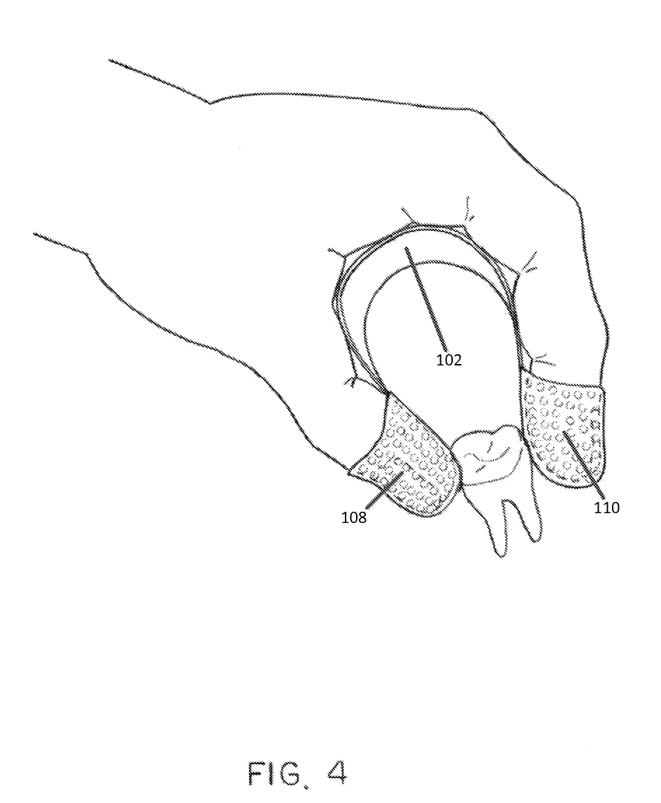

In implementations, the tooth removal cloth 100 may include a gripping portion 104, as seen in FIG. 1. The gripping portion 104 may be formed of a material which promotes enhanced (e.g., slip-resistant) gripping of the cloth 100 by human hands. For example, the gripping portion may be formed of rubber, isoprene polymer-based material, elastomeric material, latex-based material and/or the like. In further embodiments, the gripping portion 104 may include a textured surface 106. For example, the textured surface 106 may include surface features, such as bumps, ridges, protrusions, recesses, notches and/or the like for promoting enhanced gripping of the cloth. In one or more examples, the textured surface 106 may include folds, notches or may form cut-out portions sized for at least partially receiving a human finger or thumb, thereby promoting grasping of the cloth 100. Illustrated in FIG. 4, the gripping portion 104 may have a first fold 108 for insertion of a person's index finger and a second fold 110 for insertion of the person's thumb.

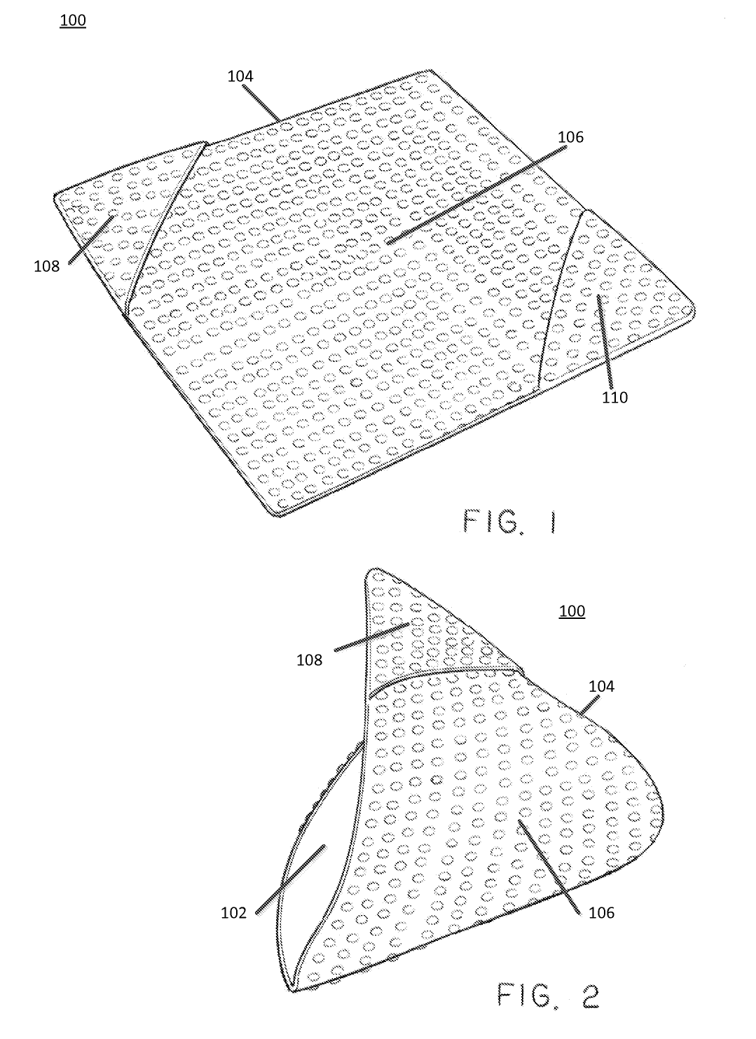

In embodiments, the tooth removal cloth 100 may include a moisture absorbing portion 102, as seen (in part) in FIG. 2. The moisture absorbing portion 102 may be formed of a moisture absorbing material. For example, the moisture absorbing material may be cotton, gauze, polyester, polyamide material, or a blend of two or more thereof.

In embodiments, the moisture absorbing portion 102 and the gripping portion 104 may form opposite faces (e.g., sides) of the cloth 100. For example, the moisture absorbing portion 102 and the gripping portion 104 may be affixed together (e.g., adhered, sewn or stitched, stapled, etc.), such that they form opposite faces (e.g., sides) of the cloth 100. In implementations, a numbing agent (e.g., a local anesthetic, oral analgesic, and/or over-the-counter topical pain relief substance) may be integrated with and/or applied to the moisture absorbing portion 102 (e.g., the moisture absorbing portion 102 is pre-treated with the numbing agent). For example, in some implementations, the moisture absorbing portion 102 may be infused (i.e., coated or saturated) with a numbing agent on the outward surface of moisture absorbing portion 102 that contacts a person's teeth and/or other parts of the mouth. For instance, the numbing agent may be benzocaine, anbesol, cepacol, lanacane, lidocaine, ethyl-4-aminobenzoate, and/or the like.

In examples, the cloth 100 may be used by children whose primary teeth (e.g., baby teeth) are becoming loose due to the exfoliation process (e.g., because their permanent teeth are due to replace the baby teeth). For instance, the child may grasp the gripping portion 104 of the cloth 100 in his/her hand, and may direct the cloth 100 towards his/her tooth such that the moisture absorbing portion 102 of the cloth 100 engages against (e.g., at least partially surrounds) the tooth. In embodiments, the material of the moisture absorbing portion 102 allows moisture, such as saliva, blood and/or the like to be absorbed into the material for promoting ease of access to and gripping of the tooth.

In implementations, the numbing agent integrated with the moisture absorbing portion 102 may promote numbing of the area in the vicinity of the tooth (e.g., surrounding gum tissue). In this way, the cloth 100 may provide a soothing effect for the child when he/she is using the cloth 100 to grab, wiggle and/or remove a loose baby tooth.

In implementations, the cloth 100 may be configured in any one of a number of various different shapes and sizes. For example, the cloth 100 may be generally square and may measure 2 inches by 2 inches (2 in.×2 in.). In embodiments, the cloth 100 may include one or more designs, patterns, themes, and/or colors, such as for promoting aesthetic appeal of the cloth 100, ease of use of the cloth 100, and/or the like. For example, either or both the moisture absorbing portion 102 and the gripping portion 104 may have a design, pattern, theme and/or color. The cloth 100 disclosed herein may make the process of wiggling and removing a loose baby tooth easier and less scary for a young child.

Although the subject matter has been described in language specific to structural features, it is to be understood that the subject matter defined in the appended claims is not necessarily limited to the specific features described above. Rather, the specific features described above are disclosed as example forms of implementing the claims.

What is claimed is:

1. A tooth removal cloth for grabbing and wiggling a tooth, the tooth removal cloth comprising:
a gripping portion, the gripping portion formed of a material for promoting gripping the cloth by hand, the gripping portion forming a first face of the cloth;
a moisture absorbing portion, the moisture absorbing portion formed of a material for promoting absorption of moisture, the moisture absorbing portion forming a second face of the cloth, the second face disposed generally opposite the first face;
wherein the moisture absorbing portion is configured for being directed toward and contacting the tooth.

2. The tooth removal cloth of claim 1, wherein the gripping portion includes a textured surface for promoting gripping of the cloth by hand.

3. The tooth removal cloth of claim 1, wherein the gripping portion includes a first fold for insertion of an index finger and a second fold for insertion of a thumb, whereby the first fold and second fold facilitate grasping the tooth.

4. The tooth removal cloth of claim 1, wherein the moisture absorbing portion includes a numbing agent.

5. A tooth removal cloth for grabbing and wiggling a tooth, the tooth removal cloth comprising:
a gripping portion, the gripping portion formed of a material for promoting gripping the cloth by hand, the gripping portion forming a first face of the cloth;
a moisture absorbing portion, the moisture absorbing portion formed of a material for promoting absorption of moisture, the moisture absorbing portion including a numbing agent, the moisture absorbing portion forming a second face of the cloth, the second face disposed generally opposite the first face,
wherein the moisture absorbing portion is configured for being directed toward and contacting the tooth.

6. The tooth removal cloth of claim 5, wherein the gripping portion includes a textured surface for promoting gripping of the cloth by hand.

7. The tooth removal cloth of claim 5, wherein the gripping portion includes a first fold for insertion of an index finger and a second fold for insertion of a thumb, whereby the first fold and second fold facilitate grasping the tooth.

8. A tooth removal cloth for grabbing and wiggling a tooth, the tooth removal cloth comprising:
a gripping portion, the gripping portion forming a first face of the cloth, the gripping portion including
a textured surface for promoting gripping of the cloth by hand, and
a first fold for insertion of an index finger and a second fold for insertion of a thumb, whereby the first fold and second fold facilitate grasping the tooth;
a moisture absorbing portion, the moisture absorbing portion formed of a material for promoting absorption of moisture, the moisture absorbing portion forming a second face of the cloth, the second face disposed generally opposite the first face,
wherein the moisture absorbing portion is configured for being directed toward and contacting the tooth.
